(19) United States
(12) Patent Application Publication
(10) Pub. No.: US 2001/0044079 A1
(43) Pub. Date: Nov. 22, 2001

(54) Photopolymerizable photosensitive phosphor paste composition and method for forming fluorescent film of the same in PDP

(75) Inventors: Lee Soon Park, Taegu-Kwangyokshi (KR); Hyun Shik Oh, Kyongsangnam-do (KR)

Correspondence Address: FLESHNER & KIM, LLP, P.O. Box 221200, Chantilly, VA, 20153-1200, US

(73) Assignee: LG Electronics Inc.

(21) Appl. No.: 09/859,584

(22) Filed: May 18, 2001

Related U.S. Application Data
(63) Continuation-in-part of application No. 09/383,634, filed on Aug. 26, 1999.

(30) Foreign Application Priority Data
Aug. 2, 2000 (KR) 2000-44898

(51) Int. Cl. H01J 1/64

(52) U.S. Cl. 430/321; 430/281.1; 430/270.1

(57) ABSTRACT

Photopolymerizable photosensitive phosphor paste composition useful for formation of a fluorescent film in a plasma display panel which is one of flat panel displays, and a method for forming a fluorescent film of the same in a plasma display panel.

The photopolymerizable photosensitive fluorescent paste composition includes cellulose group water soluble binder polymer 100 wt.part, multifunctional monomer or oligomer 100 wt.part, photoinitiator 20 wt.part, fluorescent material 300 wt.part, a solvent for dissolving the cellulose binder polymer 150˜550 wt.part, and photoreaction rate controller 0.1˜5 wt.part. Accordingly, different from the related art photosensitive fluorescent paste, as the photopolymerizable photosensitive fluorescent paste of the present invention can be developed by pure water, the paste is environment friendly and has a low baking temperature, that permits an easy fluorescent film formation, the present invention is suitable for formation of a fluorescent film for a large sized screen over 40″ and an HDTV PDP.

### BACKGROUND OF THE INVENTION

1. Field of the Invention

The present invention relates to a photopolymerizable photosensitive fluorescent paste composition and a method for forming a fluorescent film of the same, and more particularly, to a photopolymerizable photosensitive phosphor paste composition useful for formation of a fluorescent film in a plasma display panel which is one of flat panel displays, and a method for forming a fluorescent film of the same in a plasma display panel.

2. Background of the Related Art

As one of flat displays employing a phenomenon in which a vacuum UV ray(with a wavelength approx. 147 nm) emitted from plasma produced when an inert gas is discharged is turned into red, green and blue lights in the visible light range when the UV ray is incident to red, green and blue fluorescent films respectively, the plasma display panel(called as ‘PDP’ hereafter) attracts attention as one of the next generation displays, such as HDTV, in view that the PDP can make a full color display, has a fast response and a wide angle of view, and is easy to realize a large sized display over 40″. The fluorescent film in the PDP is thin films of fluorescent materials which can emit red, green, and blue colors respectively coated inside of space surrounded by a barrier with a height 150 μm at 200 nm˜300 nm intervals on a lower glass substrate of the PDP, to make full color of the PDP available, and is an important component that fixes a quality of the PDP as a luminance of the panel is dependent on the fluorescent film. The PDP fluorescent film may be formed by screen printing or photolithgraphy. However, since a contact area between a screen mask and the glass substrate in which the barrier is to be formed is small, when it is intended to form the PDP fluorescent film by the screen printing, there is a problem in that it is difficult to obtain a uniform thickness at sides of the barrier and in the glass substrate unless a special care is taken in controlling fluidity of the fluorescent paste. Particularly, in a case of an HDTV PDP with a size larger than 40″, it is very difficult to apply a uniform coat of fluorescent paste between barrier precisely throughout the glass substrate by the screen printing. Eventually, a photolithography using a liquid photosensitive fluorescent paste is suggested as a screen printing method suitable for a large sized HDTV PDP.

As a material of the PDP fluorescent film by the photolithography, a PVA-ADC type photosensitive fluorescent paste is suggested in U.S. Pat. No. 5,086,297 in 1989, which may be prepared by dissolving ammonium dichromate (call as ‘ADC’ hereafter) in a water solution of polyvinyl alcohol (call as ‘PVA’ hereafter) used in formation of a fluorescent film in a color TV CRT, and dispersing fluorescent material therein. However, since a structure and materials of the PDP are different from a TV CRT, the dichromate residue degrades the PDP fluorescent material and drops a luminance during operation of the PDP. U.S. Pat. No. 5,136,207 in 1990 and U.S. Pat. No. 5,601,468 in 1996 suggest use of a PVA-DAST photosensitive fluorescent paste in formation of the PDP fluorescent film, which may be prepared by dissolving 4, 4′-diazidostilbene-2,2′-disulfonic acid sodium salts, one of water soluble photosensitive agents, in PVA water solution and dispersing fluorescent material therein. However, as developments of the PDP advance, there have been problems in that formation of a uniform fluorescent film is difficult because, not only application of a reflection type fluorescent film on a PDP panel of a non-flat structure, of a photo cross-linking photosensitive paste, such as PVA-ADC and PVA-DAST is difficult, but also the photo cross-linking photosensitive paste has a weak adhesive force.

The foregoing related art photo cross-linking type photosensitive fluorescent paste will be explained in more detail. FIG. 1 illustrates a chemical formula showing a photoreaction mechanism of the related art photo cross-linking type photosensitive fluorescent paste of PVA-ADC, schematically. FIG. 2 illustrates a chemical formula showing a photoreaction mechanism of the related art photo cross-linking type photosensitive fluorescent paste of PVA-DAST, schematically.

The related art photo cross-linking type photosensitive fluorescent paste of photosensitive polymer composition, such as PVA-ADC and PVA-DAST, is prepared by dissolving PVA-ADC or PVA-DAST which induces a photo cross-linking reaction in water, a solvent, and dispersing one of red, green, and blue fluorescent material powder therein, wherein the fluorescent material powder is included in the photosensitive fluorescent paste by 20˜30 wt. %, the water, a solvent, by 20˜30 wt. %, with balance of PVA-ADC or PVA-DAST. Upon coating and drying the photosensitive fluorescent paste on the glass substrate having the barriers formed thereon, most of the water, a solvent, is vaporized, and the photosensitive polymer composition of PVA-ADC or PVA-DAST encapsulate the fluorescent powder, to form micron grains of diameters ranging 3 μm˜6 μm, which are stacked to form a composite membrane of fluorescent material photosensitive polymer of a thickness ranging approx. 20˜30 μm. Upon directing an UV ray to the composite membrane of fluorescent material/photosensitive polymer with a mask placed thereon, an exposed portion is altered into megapolymer groups of three dimensional network structure by a photo cross-linking reaction of a mechanism as shown in FIGS. 1 and 2, and becomes insoluble in water, to remain during the development, while portions not exposed are removed, permitting to form a desired fluorescent material pattern. In this instance, as shown in FIG. 1, in the PVA-ADC group photoreaction mechanism, a Cr(VI) ion included in the ADC is altered into Cr(III) ion by the UV ray to form a complex with an —OH in PVA, resulting to form a megapolymer group insoluble in water which is a developer. As shown in FIG. 2, in the PVA-DAST group photoreaction mechanism, DAST, a water soluble photosensitive agent, is decomposed by an UV ray, to form nitrene groups having a high activity, which makes a hydrogen abstraction reaction with PVA, a polymer, to form a photo cross-linked polymer insoluble in water which is a developer. Though the photo cross-linking photosensitive fluorescent paste of a photosensitive polymer composition, such as PVA-ADC or PVA-DAST is applicable in formation of fluorescent film in a color TV CRT with a thickness around 10 μm, the paste is not applicable in formation of the PDP fluorescent film having a thickness ranging 20˜30 μm before exposure due to a poor adhesive force coming from a difference of cross-linking densities. This is because the cross-linking density is varied with a number of chrome ions in DAST or ADC, a photosensitive agent, in the photo cross-linking photosensitive fluorescent paste, which makes a direct bonding with PVA, a polymer, and such reaction can be occurred only when an UV ray is directed onto photosensitive agents, such as DAST and Cr(VI), directly. Therefore, as a photo energy of an UV ray becomes the less due to absorption and reflection by the fluorescent material grains as the film becomes the thicker, the cross-linking may not be occurred or inadequate due to lack of the photo energy of the UV ray at a portion the film is required to make bonding to the substrate. Therefore, the contact portion, which is the deepest portion of the film, between the glass substrate and the fluorescent film remained in a state not being cross-linked is bulged or dissolved by a developer during a development, leading loss of an exposed fluorescent portion that is required to remain.

To solve the problem occurred when the PVA-VAC or PVA-DAST is used, a photopolymerizable photosensitive fluorescent paste has been developed, which uses acrylate group polymer having a carboxyl group as a binder. According to an experiment conducted by the inventors on a fluorescent film of the photopolymerizable photosensitive fluorescent paste with acrylate group polymer used as a binder, it is found that the fluorescent film has problems in that the baking temperature after formation of the fluorescent film is high, residual inorganic alkali metal after development affects the fluorescent film, the alkali developer pollutes environment, and variation of line widths and sharpness of fluorescent film pattern are wide depending on exposure.

### SUMMARY OF THE INVENTION

Accordingly, the present invention is directed to a photopolymerizable photosensitive phosphor paste composition, and a method for forming a fluorescent film in a plasma display panel by using the same that substantially obviates one or more of the problems due to limitations and disadvantages of the related art.

An object of the present invention is to provide a photopolymerizable photosensitive phosphor paste composition, and a method for forming a fluorescent film in a plasma display panel by using the same, which uses pure water as a developer, has a low baking temperature after formation of fluorescent film and is easy to control a line width and sharpness of the fluorescent film pattern.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the photopolymerizable photosensitive fluorescent paste composition includes cellulose group water soluble binder polymer 100 wt.part, multifunctional monomer or oligomer 100 wt.part, photoinitiator 20 wt.part, fluorescent material 300 wt.part, a solvent for dissolving the cellulose binder polymer 150˜550 wt.part, and photoreaction rate controller 0.1˜5 wt.part.

In another aspect of the present invention, there is provided a method for forming a fluorescent film of a photopolymerizable photosensitive fluorescent paste composition, including (1) a first fluorescent film forming step including the sub-steps of (1-1) coating photopolymerizable photosensitive fluorescent paste composition as claimed in claim 1 on a glass substrate with barriers formed therein to a thickness ranging 30˜70 μm, (1-2) heating and drying at a temperature ranging 100˜140° C. for 10˜30 min., (1-3) aligning a mask, and exposing for 20˜60 seconds, and (1-4) developing the paste composition on the glass substrate using pure water, (2) a second fluorescent film forming step for repeating the step (1) using the photopolymerizable photosensitive fluorescent paste composition containing a fluorescent material of a color different from the fluorescent material used in the step (1), (3) a third fluorescent film forming step for repeating the step (1) using a photopolymerizable photosensitive fluorescent paste composition containing a fluorescent material of a color different from the fluorescent material used in the steps (1) and (2), and (4) a baking step for heating and baking the glass substrate having fluorescent films of red, green and blue colors formed thereon at a temperature ranging 450˜550° C.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a chemical formula of photoreaction mechanism of a related art photo cross-linking type photosensitive fluorescent paste of PVA-ADC, schematically;

FIG. 2 illustrates a chemical formula of a photoreaction mechanism of a related art photo cross-linking type photosensitive fluorescent paste of PVA-DAST, schematically;

FIG. 3 schematically illustrates the steps of a method for forming a fluorescent film in a PDP by photolithography using a photopolymerizable photosensitive fluorescent paste composition formed in accordance with a preferred embodiment of the present invention; and,

FIG. 4 illustrates a thermal analysis graph showing thermal decomposition characteristics of binder polymer used for a photopolymerizable photosensitive fluorescent paste formed in accordance with a preferred embodiment of the present invention.

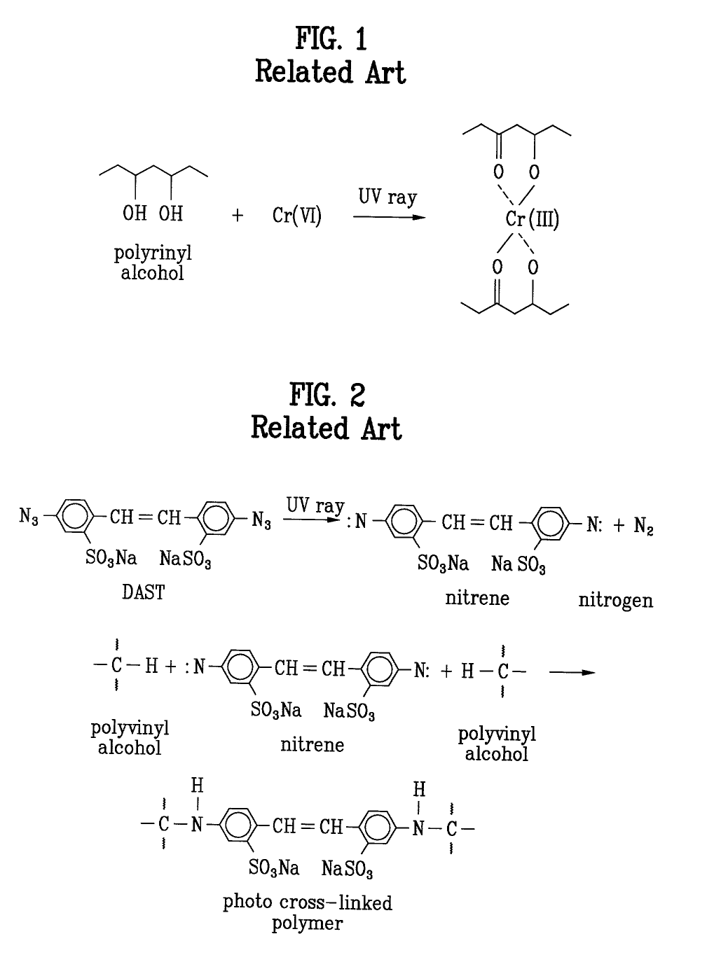

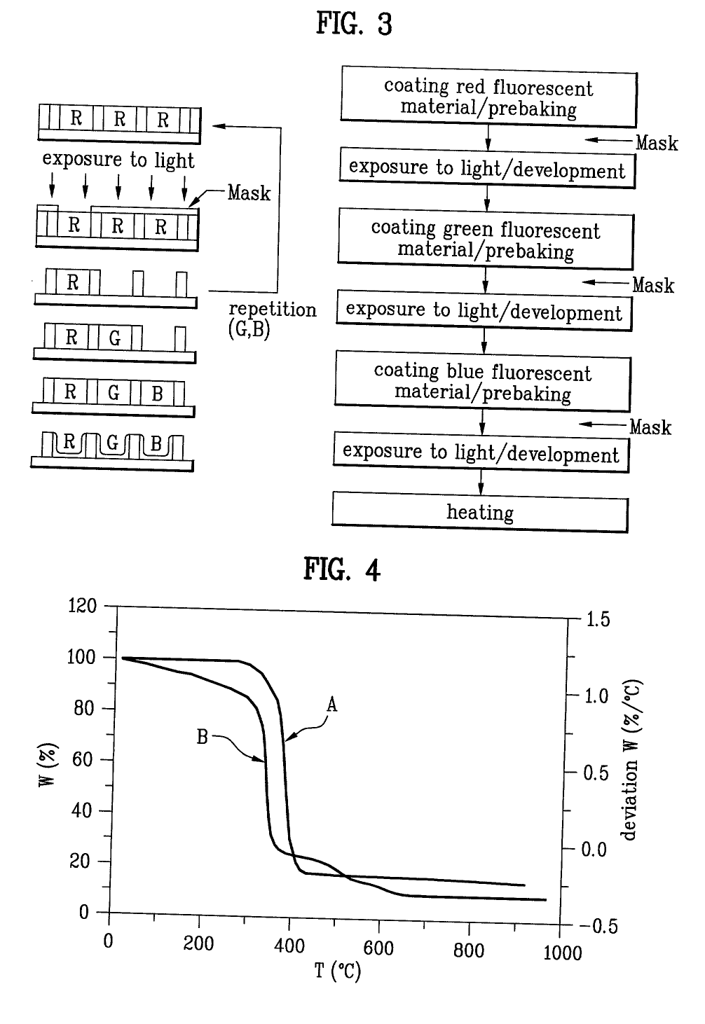

### DETAILED DESCRIPTION OF THE PREFERRED EMBODIMENT

Reference will now be made in detail to the preferred embodiments of the present invention, examples of which are illustrated in the accompanying drawings. A photopolymerizable photosensitive fluorescent paste composition in accordance with a preferred embodiment of the present invention includes cellulose group water soluble binder polymer 100 wt.part, multifunctional monomer or oligomer 100 wt.part, photoinitiator 20 wt.part, fluorescent material 300 wt.part, a solvent which can dissolve the cellulose binder polymer 150˜550 wt.part, and photoreaction rate controller 0.1˜5 wt.part.

It is preferable that the photoreaction rate controller is selected from a group including hydroquinone, hydroquinone monomethyl ether, p-benzoquinone, and a mixture of above.

The photopolymerizable photosensitive fluorescent paste composition formed in accordance with a preferred embodiment of the present invention includes additives selected from a group including dispersant, smoother, and photosensitizer, additionally.

The method for forming a fluorescent film of a photopolymerizable photosensitive fluorescent paste composition in accordance with a preferred embodiment of the present invention includes (1) a first fluorescent film forming step having the sub-steps of (1-1) coating the above photopolymerizable photosensitive fluorescent paste composition on a glass substrate with barriers formed thereon to a thickness ranging 30˜70 μm, (1-2) heating and drying at a temperature ranging 100˜140° C. for 10˜30 min., (1-3) aligning a mask, and exposing for 20˜60 seconds, and (1-4) developing the paste composition on the glass substrate using pure water, (2) a second fluorescent film forming step for repeating the step (1) using the photopolymerizable photosensitive fluorescent paste composition containing a fluorescent material of a color different from the fluorescent material used in the step (1), (3) a third fluorescent film forming step for repeating the step (1) using a photopolymerizable photosensitive fluorescent paste composition containing a fluorescent material of a color different from the fluorescent material used in the steps (1) and (2), and (4) a baking step for heating and baking the glass substrate having fluorescent films of red, green and blue colors formed thereon at a temperature ranging 450˜550° C.

A photopolymerizable photosensitive fluorescent paste composition formed in accordance with a preferred embodiment of the present invention consists of water soluble binder polymer 1 to 15 wt. %, multifunctional monomer or oligomer 3 to 7 wt. %, photoinitiator 1 to 3 wt. %, fluorescent material 25 to 35 wt. %, a solvent which can dissolve the binder polymer 20 to 35 wt. %, and photoreaction rate controller 0.1 to 1 wt. %, and balance of additives, such as dispersant, smoother, or photosensitizer.

The water soluble binder polymer may be selected from a group including pure water or organic solvent soluble cellulose group derivatives, such as hydroxyethyl cellulose, hydroxypropyl cellulose, ethylhydroxyethyl cellulose, hydroxyalkylmethyl cellulose, hydroxyethylhydroxypropyl cellulose and dihydroxypropyl cellulose, or water soluble copolymers containing water soluble monomers, such as acrylamide, diacetone acrylamide and vinyl pyrrolidinone, or water soluble copolymers containing oil soluble monomers, such as methylmethaccrylate and α-methylstyrene. The binder polymer may be selected from pure water or organic solvent soluble cellulose group derivatives, preferably from polymers having a molecular weight ranging 10,000˜500,000 g/mole, with a kinetic viscosity of 20,000˜40,000 cps when coated on an entire surface, and 100,000 cps during storage. If the molecular weight is too low, a binder polymer content in the photosensitive fluorescent paste should be adjusted for adjustment of fluidity characteristics, wherein an increased binder polymer content may cause a problem of prolonged baking time period and an decreased binder polymer content may cause a problem of deteriorated storage stability, such as precipitation of inorganic fluorescent material for a prolonged storage. And, a too high molecular weight of the binder polymer may cause problems of deterioration of solubility to a solvent as well as deterioration of wettability and dispersability to inorganic fluorescent material grains, and a too low molecular weight of the binder polymer may cause problems of prolonged baking time period or higher baking temperature, that deteriorates compactness of the fluorescent film after the baking, to require an increased binder polymer content for the photosensitive paste to have an appropriate viscosity. And, a too low viscosity of the binder polymer may cause problems of uneven coating of the fluorescent paste on a barrier sidewall surface to result to lie in a heap on an underlying glass substrate, and a too high viscosity of the binder polymer may cause a problem of causing a thickness difference due to concentration of the fluorescent paste at a top portion of the barrier coming from a poor flowability.

The multifunctional monomer or oligomer may be selected from a group including multifunctional monomers, such as ethyleneglycol diacrylate, diethyleneglycol diacrylate, methyleneglycol bisacrylate, propylene diacrylate, 1,2,4-butanetriol triacrylate, 1, 4-benzenediol diacrylate, trimethylolpropane triacrylate, trimethylolpropane trimethacrylate, pentaerythritol tetraacrylate, pentaerythritol tetramethaacrylate, dipentaerythritol hexaacrylate and dipentaerythritol hexamethaacrylate, and multifunctional oligomers, such as melamine acrylate, epoxy acrylate, urethane acrylate, polyester acrylate, polyethylene glycol bisacrylate with a molecular weight ranging 200˜500 and polypropylene glycol bismethaacrylate with a molecular weight ranging 200˜500. As the epoxy acrylate oligomer, Ebecryl 600, 605, 616, 639 and 1608 are commercially available from UCB, as aliphatic urethane acrylate oligomer, Ebecryl 264, 265, 284 and 8804 are available, as aromatic urethane acrylate oligomer, Ebecryl 220, 4827 and 4849 are available, and as polyester acrylate oligomer, Ebecryl 80 and 150 are commercially available.

As the photoinitiator, any of photoinitiators that exibits an excellent photoreaction in an UV wavelength range may be used, for example, 2,4-dimethoxy-2-phenyl acetophenone(called as ‘DMPA’ hereafter) may be used singly or as a composition of a mixture photoinitiator having more than two photoinitiators mixed therein. As a cross-linking capability can be provided for various wavelength ranges, the mixture photoinitiator can provide an excellent fluorescent film pattern. Therefore, photoinitiators, such as 1-hydroxy-cyclohexyl-phenylketone, p-phenylbenzophenone, benzyldimethylketal, 2,4-dimethyl thioxanthone, 2,4-diethyl thioxanthone, benzoin ethyl ether, benzoin isobutyl ether, 4,4′-diethylaminobenzophenone and p-dimethyl amino benzoic acid ethylester, or a mixture of two or more than two of them may be used as the photoinitiator.

As the fluorescent material, Y₂O₃:Eu, Y₂SiO₅:Eu, Y₃Al₅O₁₂:Eu, Zn₃(PO₄)₂:Mn, YBO₃:Eu, (Y,Gd)BO₃:Eu, GdBO₅:Eu and ScBO₃:Eu may be used for red color, Y₂SiO₅:Ce, CaWO₄:Pb and BaMgAl₁₄O₂₃:Eu may be used for blue color, and Zn₂SiO₄:Mn, BaAl₁₂O₁₉:Mn, SrAl₁₃O₁₉:Mn, CaAl₁₂O₁₉:Mn, YBO₃:Tb, BaMgAl₁₄O₂₃:Mn, LuBO₃:Tb, ScBO₃:Tb and Sr₆Si₃O₈C₁₄:Eu may be used for green color, and, other than these, any fluorescent materials that can emit red, green, or blue visible lights may be used.

The solvent for the photosensitive fluorescent paste may be selected from a group including N-methyl pyrrolidone, ethylene glycol, 2-butoxy ethoxy ethanol, cellosolve, 2-ethoxy ethanol, 3-methoxy-3-methyl butanol, terpineol and dimethyl formamide and dimethyl acetamide, which have a boiling higher than 100° C., or mixtures of two or more than two of them.

As the photoreaction rate controllers, there are hydroquinone, hydroquinone monomethyl ether, p-benzoquinone. When no photoreaction rate controller is used, the photopolymerization proceeds to an unexposed portion, to widen line widths of the pattern, to cover entire printing surface if the exposure is extensive, a time period required for the development is prolonged, and sharpness of the pattern is poor.

For improving fluidity and process performance of the photosensitive fluorescent paste as the additives, various additives, such as a photosensitizer such as benzophenone, acryl group dispersant such as alcosperse 602-N, silicon group anti-foamer such as BYK 307, smoother such as BYK 320 or HS-70 from SK-UCB, anti-oxidant such as Iganox 1010 from Cyba geigy co., and the like may be used, which are well known to a person skilled in the field to purchase and use.

Provided for solving the problems of the related art photopolymerizable photosensitive fluorescent paste, i.e. the problems of a poor baking characteristic of the binder polymer, the wide variation of line width depending on exposure, and the poor fluorescent film pattern sharpness, the photopolymerizable photosensitive fluorescent paste consists of one of red, green and blue fluorescent material, binder polymer for binding the fluorescent material, multifunctional monomer or oligomer participating in photopolymerization, UV ray photoinitiator, solvent and photoreaction rate controller, and is featured in that develpment by pure water is possible. That is, upon coating and drying the photopolymerizable photosensitive fluorescent paste on the PDP glass substrate having barriers formed thereon, the solvent is vaporized and removed, to form a fluorescent material/photosensitive polymer composite membrane consisting of fluorescent material, binder polymer, multifunctional monomer or oligomer, photosensitizer and the like. Upon direction of an UV ray to the composite membrane through a mask, the photoinitiator is decompsed, to form a free radical which makes double bonding polymerization of the multifunctional monomer or oligomer distributed between the binder polymer surrounding micron fluorescent grains, to form a three dimensional network of polymer groups, which is not soluble in a solvent, in the composite membrane. In this instance, under the control of the photoreaction rate controller, the free radical produced by the UV ray gives an influence to the fluorescent film line width and the fluorescent film pattern sharpness to facilitate formation of a high quality fluorescent film. Different from the photo cross-linking type photosensitive fluorescent paste, such as PVA-DAST, in the photopolymerizable photosensitive fluorescent paste of the present invention, because a photopolymerization reaction is occurred under a chain polymerization reaction mechanism owing to residual radicals formed by decomposition of the photoinitiator by an UV ray at portions, not only just beneath a surface of the fluorescent grain, but also just above the glass substrate to which the UV ray reaches with difficulty, a thick fluorescent film pattern suitable for a PDP can be obtained with easy.

The role of the binder polymer which acts as a binder of the fluorescent material is very important in the photopolymerizable photosensitive fluorescent paste of the present invention.

While the binder polymer in the photopolymerizable photosensitive fluorescent paste of the present invention does not participate in photopolymerization reaction at all, in the case of the related art photo cross-linking type photosensitive fluorescent paste, such as PVA-ADC or PVA-DAST, PVA, acting as a binder polymer, participates in photoreaction, together with DAST or Cr(III), directly. And, in preparation of the photopolymerizable photosensitive fluorescent paste composition of the present invention, the development process varys with kinds of binder polymers. It is preferable that the binder polyer is soluble both in water solution and organic solvent, particularly, one that is soluble in pure water is favorable in view of cost, working environment, and environmental pollution because use of pure water as a development liquid is allowed. In a case when an acrylate group polymer having carboxyl group is used as the binder, there can be a problem in that the fluorescent material may be contaminated by residual alkali metal because a strong alkali solution, such as NaOH, should be used in development.

The action of the photoreaction rate controller in the photopolymerizable photosensitive fluorescent paste composition of the present invention has a close relation with the formation of the fluorescent film pattern.

The photoreaction rate controller makes the photopolymerization between the exposed portion and the unexposed portion distinct in the formation of the fluorescent film, and, if the photoreaction rate controller is used to be 0.1˜5 wt. % of the cellulose binder polymer, a fluorescent film having an excellent sharpness can be obtained. If no photoreaction rate controller is used, the line width becomes larger according to an amount of the exposure, and, at times, the photopolymerization is occurred throughout the surface of the coated fluorescent paste, failing to form the pattern, at all. And, the sharpness of the pattern also poor, and a longer development time period is required. An excessive use of the photoreaction rate controller over the range may impede the photopolymerization reaction despite of the exposure, and makes an adhesive force with an underlying barrier poor, resulting in loss of the pattern during the development.

As a ratio of the cellulose binder polymer and a solvent have control over the fluidity of the photosensitive fluorescent paste, the ratio is important for the process for forming the fluorescent film. An appropriate ratio of mix of the cellulose binder polymer and the solvent is in a range of 150˜550 wt. % of the cellulose binder polymer, wherein, if the ratio of mix is lower than this range, viscosity of the photosensitive fluorescent paste is too high to disperse into an inside of the barrier evenly when the photosensitive fluorescent paste is coated on the glass substrate, and, if the ratio of mix is higher than this range, viscosity of the photosensitive fluorescent paste is too low for the fluorescent material to disperse in the paste evenly, but deposit, or to require a long time period for drying.

The method for forming a fluorescent film of a photopolymerizable photosensitive fluorescent paste composition in accordance with a preferred embodiment of the present invention includes (1) a first fluorescent film forming step having the sub-steps of (1-1) coating photopolymerizable photosensitive fluorescent paste composition on a glass substrate with barriers formed thereon to a thickness ranging 30˜70 μm, which paste composition consists of water soluble binder polymer 1˜15 wt. %, multifunctional monomer or oligomer 3˜7 wt. %, photoinitiator 1˜3 wt. %, one of red, green and blue fluorescent materials 25˜35 wt. %, a solvent which can dissolve the binder polymer 20˜35 wt. %, photoreaction rate controller 0.1˜1 wt. %, and balance of additives, such as dispersant, smoother or photosensitizer, (1-2) heating and drying at a temperature ranging 100˜140° C. for 10˜30 min., (1-3) aligning a mask, and exposing for 20˜60 seconds, and (1-4) developing the paste composition on the glass substrate using pure water, (2) a second fluorescent film forming step for repeating the step (1) using the photopolymerizable photosensitive fluorescent paste composition containing a fluorescent material of a color different from the fluorescent material used in the step (1), (3) a third fluorescent film forming step for repeating the step (1) using a photopolymerizable photosensitive fluorescent paste composition containing a fluorescent material of a color different from the fluorescent material used in the steps (1) and (2), and (4) a baking step for heating and baking the glass substrate having fluorescent films of red, green and blue colors formed thereon at a temperature ranging 450˜550° C.

Thus, the present invention forms fluorescent films of red, green, and blue three colors of photopolymerizable photosensitive fluorescent materials which is photopolymerizable by direction of a UV ray thereto in succession by coating, development, and baking.

In the exposing in the step (3), an UV ray of a wavelength in the vicinity of 250˜380 nm, preferably at a light intensity of 5˜10 mW/cm², is employed. The coating, drying, exposure and development used in the formation of the fluorescent film are similar to the coating, drying, exposure and development used in a general semiconductor device fabrication process, known to a person skilled in the field of art.

Examples of the present invention will be explained, which is illustrated as examples, but not to limit the scope of the present invention.

### EXAMPLES 1 TO 4

A photopolymerizable photosensitive fluorescent paste is prepared by mixing hydroxyethyl cellulose(called as ‘HEC’ hereafter), hydroxypropyl cellulose(called as ‘HPC’ hereafter), and a copolymer(called as ‘ADCP’ hereafter) of acryl amide and diacetone acrylamide, as binder polymers of the photopolymerizable photosensitive fluorescent paste for facilitating development using pure water, dimethylformamide(called as ‘DMF’ hereafter), N-methyl-2-pyrrolidone(called as ‘NMP’ hereafter) and 3-methoxy-3-methyl-butanol, as solvents, pentaerythritol triacrylate(called as ‘PETA’ hereafter) as a multifunctional monomer, 2-hydroxyethyl acrylate(called as ‘HEA’ hereafter) as singlefunctional monomer, hydroquinone as a photoreaction rate controller, a brand name HSP-188 as an UV ray photoinitiator and a brand name BYK 320 as a smoother as shown in table 1.

The prepared photopolymerizable photosensitive fluorescent paste is printed on an entire surface of a glass substrate having barriers formed thereon by a printer, heated and dried at 120° C. for 20 minutes, to vaporize and remove the solvent. Then, a mask is aligned to the glass substrate having the fluorescent film coated thereon, and an UV ray is directed thereto at a light intensity 7 mW/cm² for 30 seconds. Pure water is used in removing non-exposed portions, dried, and a state of the formed fluorescent film is examined using optical microscope, of which result is shown in table 1.

TABLE 1
Preparation of photopolymerizable photosensitive fluorescent paste composition
and Properties of fluorescent film of the same.

| Example 1 | | Example 2 | | Example 3 | | Example 4 | |
|---|---|---|---|---|---|---|---|
| HEC | 2 g | HPC | 2 g | HPC | 10 g | ADCP | 15 g |
| (molecular | | (molecular | | (molecular | | | |
| weight | | weight | | weight | | | |
| 360,000) | | 360,000) | | 80,000) | | | |
| DMF | 40 g | DMF | 40 g | 3-methoxy-3- | 40 g | NMP | 40 g |
| | | | | methyl | | | |
| | | | | butanol | | | |
| PETA | 5 g | PETA | 5 g | PETA | 5 g | PETA | 5 g |
| HEA | 5 g | HEA | 5 g | HEA | 5 g | HEA | 5 g |
| HSP-188 | 1 g | HSP-188 | 1 g | HSP-188 | 3 g | HSP-188 | 3 g |
| Hydroquinone | 0.2 g | hydroquinone | 0.2 g | hydroquinone | 0.2 g | hydroquinone | 0.2 g |
| BYK 320 | 0.3 g | BYK 320 | 0.3 g | BYK 320 | 0.3 g | BYK 320 | 0.3 g |
| fluorescent | 30 g | fluorescent | 30 g | fluorescent | 30 g | fluorescent | 30 g |
| material | | material | | material | | material | |
| viscosity | 18 | viscosity | 16 | viscosity | 25 | viscosity | 15 |
| (cps) × 1000 | | (cps) × 1000 | | (cps) × 1000 | | (cps) × 1000 | |
| thickness of | 30 | thickness of | 28 | thickness of | 32 | thickness of | 27 |
| fluorescent | | fluorescent | | fluorescent | | fluorescent | |
| film (μm) | | film (μm) | | film (μm) | | film (μm) | |
| fall off ratio | 0 | fall off ratio | 0 | fall off ratio | 1 | fall off ratio | 0 |
| of fluorescent | | of fluorescent | | of fluorescent | | of fluorescent | |
| film (%) | | film (%) | | film (%) | | film (%) | |
| sharpness (%) | 0.1 | sharpness (%) | 0.2 | sharpness (%) | 0.2 | sharpness (%) | 0.5 |

*Sharpness: an extent of deviation from a straight line at a boundary between an exposed portion and a non-exposed portion.

In summary of the foregoing examples, a uniform fluorescent film ranging 27˜32 μm is obtained on a barrier sidewall and on the underlying glass substrate, a fall off ratio of the fluorescent film is found to be below 1%, and a sharpness which is an extent of deviation from a straight line at a boundary between an exposed portion and a non-exposed portion is also below ±1%. And, as shown in FIG. 4, as a result of TGA thermal analyses of baking temperatures, in comparison that the acrylate group binder polymer in example 3 shows a maximum decomposition at a temperature approx. 394° C., because all the cellulose group binder polymers in examples 1, 2 and 4 show a maximum decomposition at a temperature approx. 339° C., it is verified that a thermal alteration of the fluorescent can be prevented in baking. And, though a viscosity of the photopolymerizable photosensitive fluorescent paste having acrylate group binder polymer therein in the example 3 is 15,000 cps when a content of the binder polyer is approx. 10%, as a viscosity of the photopolymerizable photosensitive fluorescent paste having cellulose group binder polymer therein in the example 1, 2 and 4 are 16,000 cps when a content of the binder polyer is approx. 3%, showing that a higher viscosity can be obtained by a smaller amount of binder polymer, it is verified that a residual binder after baking can be minimized.

### COMPARATIVE EXAMPLE 1

Preparation of photo cross-linking type photosensitive fluorescent paste of PVA-ADC and properties of a fluorescent film formed thereof.

4.26 g(5.4%) PVA with a molecular weight 77,000 is dissolved in 43 g(54.1%) pure water, 1.53 g(1.9%) of ADC as a photosensitizer, 0.53 g(0.7%) of dispersant, 0.1 g(0.1%) anti-foamer and 30 g(37.8%) fluorescent material are mixed therein, and the fluorescent material is distributed by a roll-mill, to prepare a photosensitive fluorescent paste. The prepared photosensitive fluorescent paste is printed on an entire surface of a PDP glass substrate having barriers formed thereon by a printer, heated and dried to vaporize and remove water, a solvent. A mask is aligned on the glass substrate having the fluorescent film coated thereon, an UV ray is directed thereto at a light intensity of 7 mW/cm² for 30 seconds, and the fluorescent film is development in pure water. Upon examining the developed fluorescent film pattern with an optical microscope, it is observed that the fluorescent film formed at a surface of the barrier sidewall is not uniform and exposed portions of the fluorescent film are fallen off by more than 20% because photo cross-linking is not made properly due to a film thickness on the underlying glass substrate.

### COMPARATIVE EXAMPLE 2

Preparation of photo cross-linking type photosensitive fluorescent paste of PVA-DAST and properties of a fluorescent film formed thereof.

5.00 g(6.1%) PVA with a molecular weight 77,000 is dissolved in 45 g(55.0%) pure water, 1.50 g(1.8%) of DAST as a photosensitizer, 0.2 g(0.2%) of dispersant, 0.1 g(0.1%) anti-foamer and 30 g(36.7%) fluorescent material are mixed therein, and the fluorescent material is distributed by a roll-mill, to prepare a photosensitive fluorescent paste. The prepared photosensitive fluorescent paste is printed on an entire surface of a PDP glass substrate having barriers formed therein by a printer, heated for 10 minutes to remove water, a solvent. A mask is aligned on the glass substrate having the fluorescent film coated thereon, an UV ray is directed thereto at a light intensity of 7 mW/cm² for 30 seconds, and the fluorescent film is developed in pure water. Upon examining the developed fluorescent film pattern with an optical microscope, it is observed that the fluorescent film is formed at a surface of the barrier sidewall partially and exposed portions of the fluorescent film are fallen off by more than 30%.

### COMPARATIVE EXAMPLE 3

As an acrylate group binder polymer having a carboxyl group, a copolymer of methylmethaacrylate and methaacrylic acid having a repeat unit molar ratio 50:50 and a molecular weight 200,000 g/mole is used. A photopolymerizable photosensitive fluorescent paste is prepared by mixing the copolymer 10 wt. %, NMP 40 wt. % as a solvent, pentaerythritol triacrylate 5 wt. % and hydroxyethyl acrylate 5 wt. % as multifunctional monomers, brand name HSP-188 from SK-UCB 3 wt. % as a photoinitiator, fluorescent material 36 wt. %, and BYK 320 1 wt. % as a smoother. The prepared photosensitive fluorescent paste is printed on an entire surface of a PDP glass substrate having barriers formed therein by a printer, heated at 90° C. for 20 minutes to remove water, a solvent. A mask is aligned on the glass substrate having the fluorescent film coated thereon, an UV ray is directed thereto at a light intensity of 7 mW/cm² for 30 seconds, and the fluorescent film is developed in pure water, to fail. It is found that the development can be made when sodium carbonate(Na₂CO₃) water solution of 1 wt. % concentration is used. The developed fluorescent film pattern is examined with an optical microscope, to find a uniform fluorescent film formed throughout the sidewalls of the barrier and on the glass substrate below the barrier, it is verified that formation of a fluorescent film is easier than using the photo cross-linking type photosensitive fluorescent paste of the first and second embodiments. However, as shown in FIG. 4, a TGA analysis of a fluorescent film formed of photopolymerizable photosensitive fluorescent paste having the acrylate group compolymer as the binder polymer shows a maximum decomposition temperature in the vicinity of 394° C., implying that a baking is required at a temperature higher than the photopolymerizable photosensitive fluorescent paste in the fourth embodiment of the present invention, it is verified that there is a degradation of the fluorescent film.

### COMPARATIVE EXAMPLE 4

As the cellulose group binder polymer, a polymer of HPC with a molecular weight 200,000 g/mole is used. A photopolymerizable photosensitive fluorescent paste is prepared by mixing the polymer 10 wt. %, 3-methoxy-3-methyl-butanol 40 wt. % as a solvent, pentaerythritol triacrylate 5 wt. % and hydroxyethyl acrylate 5 wt. % as multifunctional monomers, brand name HSP-188 from SK-UCB 3 wt. % as a photoinitiator, fluorescent material 36 wt. %, and BYK 320 1 wt. % as a smoother.

The prepared photosensitive fluorescent paste is printed on an entire surface of a PDP glass substrate having barriers formed therein by a printer, heated at 90° C. for 20 minutes to remove water, a solvent. A mask is aligned on the glass substrate having the fluorescent film coated thereon, an UV ray is directed thereto at a light intensity of 7 mW/cm² for 30 seconds, and the fluorescent film is developed in pure water. Upon examining the developed fluorescent film pattern with an optical microscope, it can be known that the fluorescent film has a sharpness poorer, and a line width of the pattern wider than the case when the photoreaction rate controller of the third embodiment is used.

As has been explained, the photopolymerizable photosensitive phosphor paste composition, and the method for forming a fluorescent film of the same have the following advantages.

Different from the related art photosensitive fluorescent paste, as the photopolymerizable photosensitive fluorescent paste of the present invention can be developed by pure water, the paste is environment friendly and has a low baking temperature, that permits an easy fluorescent film formation, the present invention is suitable for formation of a fluorescent film for a large sized screen over 40″ and an HDTV PDP.

It will be apparent to those skilled in the art that various modifications and variations can be made in the photopolymerizable photosensitive fluorescent paste composition and the method for forming a fluorescent film of the same of the present invention without departing from the spirit or scope of the invention. Thus, it is intended that the present invention cover the modifications and variations of this invention provided they come within the scope of the appended claims and their equivalents.

What is claimed is:

1. A photopolymerizable photosensitive fluorescent paste composition comprising:
cellulose group water soluble binder polymer 100 wt.part;
multifunctional monomer or oligomer 100 wt.part;
photoinitiator 20 wt.part;
fluorescent material 300 wt.part;
a solvent for dissolving the cellulose binder polymer 150˜550 wt.part; and
photoreaction rate controller 0.1˜5 wt.part.

2. A composition as claimed in claim 1, wherein the photoreaction rate controller is selected from a group including hydroquinone, hydroquinone monomethyl ether, p-benzoquinone, and a mixture of above.

3. A composition as claimed in claim 1, further comprising additives.

4. A composition as claimed in claim 3, wherein the additives are selected from a group including dispersant, smoother, and photosensitizer.

5. A composition as claimed in claim 3, wherein the additives are included 3 to 7.9 wt.part of cellulose group water soluble binder polymer 100 wt.part.

6. A method for forming a fluorescent film of a photopolymerizable photosensitive fluorescent paste composition, comprising:
(1) a first fluorescent film forming step including the sub-steps of;
(1-1) coating photopolymerizable photosensitive fluorescent paste composition as claimed in claim 1 on a glass substrate with barriers formed therein to a thickness ranging 30˜70 μm,
(1-2) heating and drying at a temperature ranging 100˜140° C. for 10˜30 min.,
(1-3) aligning a mask, and exposing for 20˜60 seconds, and
(1-4) developing the paste composition on the glass substrate using pure water;
(2) a second fluorescent film forming step for repeating the step (1) using the photopolymerizable photosensitive fluorescent paste composition containing a fluorescent material of a color different from the fluorescent material used in the step (1);
(3) a third fluorescent film forming step for repeating the step (1) using a photopolymerizable photosensitive fluorescent paste composition containing a fluorescent material of a color different from the fluorescent material used in the steps (1) and (2); and,
(4) a baking step for heating and baking the glass substrate having fluorescent films of red, green and blue colors formed thereon at a temperature ranging 450˜550° C.

7. A method as claimed in claim 6, wherein the exposing in step (1-3) includes the step of directing a UV ray of 250 to 380 nm at a light intensity of 5 to 10 mw/cm².
